(19) United States
(12) Patent Application Publication
(10) Pub. No.: US 2007/0149399 A1
(43) Pub. Date: Jun. 28, 2007

(54) Multifunctional catalyst and methods of manufacture thereof

(76) Inventors: Anthony Yu-Chung Ku, Rexford, NY (US); Lawrence Bernard Kool, Clifton Park, NY (US); Sergio Paulo Martins-Loureiro, Saratoga Springs, NY (US); Mohan Manoharan, Niskayuna, NY (US); Seth Thomas Taylor, Niskayuna, NY (US); James Anthony Ruud, Delmar, NY (US)

Correspondence Address: GENERAL ELECTRIC COMPANY;GLOBAL RESEARCH, PATENT DOCKET RM. BLDG. K1-4A59, NISKAYUNA, NY, 12309, US

(21) Appl. No.: 11/317,470

(22) Filed: Dec. 22, 2005

(51) Int. Cl. B01J 21/04

(52) U.S. Cl. 502/439; 502/304; 502/242

(57) ABSTRACT

Disclosed herein is a multifunctional catalyst system comprising a substrate; and a catalyst pair disposed upon the substrate; wherein the catalyst pair comprises a first catalyst and a second catalyst; and wherein an average particle or domain spacing between particles or domains comprising the first catalyst or the second catalyst is about 10 to about 1,000 nanometers. Disclosed herein too is a process comprising selectively functionalizing a substrate to form a functionalized substrate; reacting a first catalyst to a first region of the functionalized substrate; and reacting a second catalyst to a second region of the functionalized substrate; wherein an average particle or domain spacing between particles or domains comprising the first catalyst or the second catalyst is about 10 to about 1,000 nanometers.

### BACKGROUND

This disclosure relates to multifunctional catalysis and methods for manufacturing thereof.

Industrial processes for manufacturing certain goods (e.g., chemicals and materials) generally comprise multiple steps. In some industrial processes each of these multiple steps involves the use of a catalyst. Catalysts used for these steps are often incompatible with one another. For example, conducting a first reaction that uses a first catalyst in the proximity of a second reaction that uses a second catalyst generally results in the first or the second catalyst being rapidly poisoned. The first or the second catalyst generally ends up being poisoned because the reactants used for a particular reaction (e.g., the first reaction) may not be compatible with the catalyst used in the other reaction (e.g., the second reaction). Another reason for catalyst poisoning is because the heat generated in the first reaction may be too great for the second catalyst to handle. Catalyst incompatibility or reactant-catalyst incompatibility generally leads to longer processes that are both time-consuming and expensive. In addition, catalyst incompatibility can sometimes be overcome by using multiple catalysts, which also tends to be expensive.

In addition, when multiple catalysts are used in proximity to each other, it is desirable to immobilize the catalysts. One method of immobilizing the individual catalysts is to encapsulate them in sol-gel-derived inorganic particles. An example of immobilized catalysts is a one-pot sequence of reactions with sol-gel entrapped opposing reagents such as an enzyme and metal-complex catalysts. The encapsulated particles, including those that encapsulate one of a pair of incompatible catalysts, can be disposed within a common bath of reactants to allow a one-pot sequence of reactions. However, the particles tend to be large and separated by large diffusional distances in the bath, which reduces the reaction rates.

It is therefore desirable to have a system wherein multiple catalysts can be disposed upon a single common substrate and used to generate a desirable product without harming each other.

### SUMMARY

Disclosed herein is a multifinctional catalyst system comprising a substrate; and a catalyst pair disposed upon the substrate; wherein the catalyst pair comprises a first catalyst and a second catalyst; and wherein an average particle or domain spacing between particles or domains comprising the first catalyst or the second catalyst is about 10 to about 1,000 nanometers.

Disclosed herein too is a multifunctional catalyst system comprising a substrate; and an incompatible catalyst pair disposed upon the substrate; wherein the incompatible catalyst pair comprises a first catalyst and a second catalyst; and wherein an average particle or domain spacing between particles or domains comprising the first catalyst or the second catalyst is effective to produce a desired product that would not be produced if the average particle or the average domain spacing between the first catalyst and the second catalyst was changed.

Disclosed herein too is a process comprising selectively functionalizing a substrate to form a functionalized substrate; reacting a first catalyst to a first region of the functionalized substrate; and reacting a second catalyst to a second region of the functionalized substrate; wherein an average particle or domain spacing between particles or domains comprising the first catalyst or the second catalyst is about 10 to about 1,000 nanometers.

Disclosed herein too is a method comprising catalyzing a first reaction using a first catalyst; and catalyzing a second reaction using a second catalyst; wherein the first catalyst and the second catalyst are disposed upon a substrate and further wherein an average particle or domain spacing between particles or domains comprising the first catalyst or the second catalyst is about 10 to about 1,000 nanometers.

### DETAILED DESCRIPTION OF FIGURES

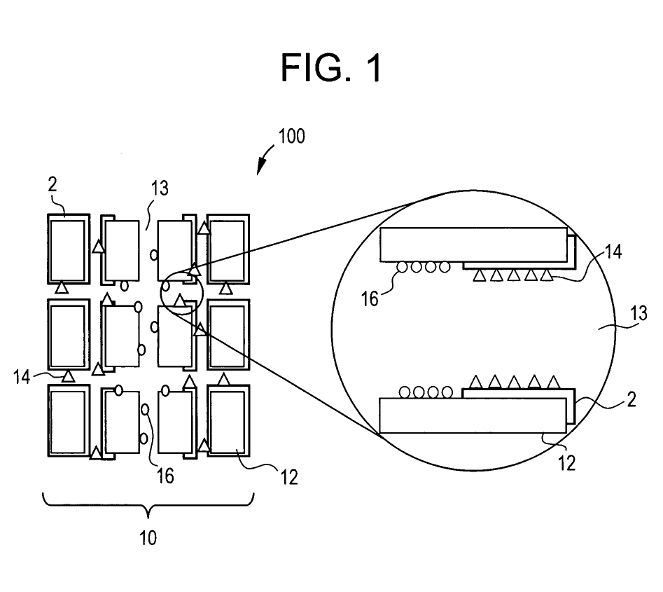

FIG. 1 is an exemplary schematic that depicts one embodiment of the structure of a multifunctional catalyst system;

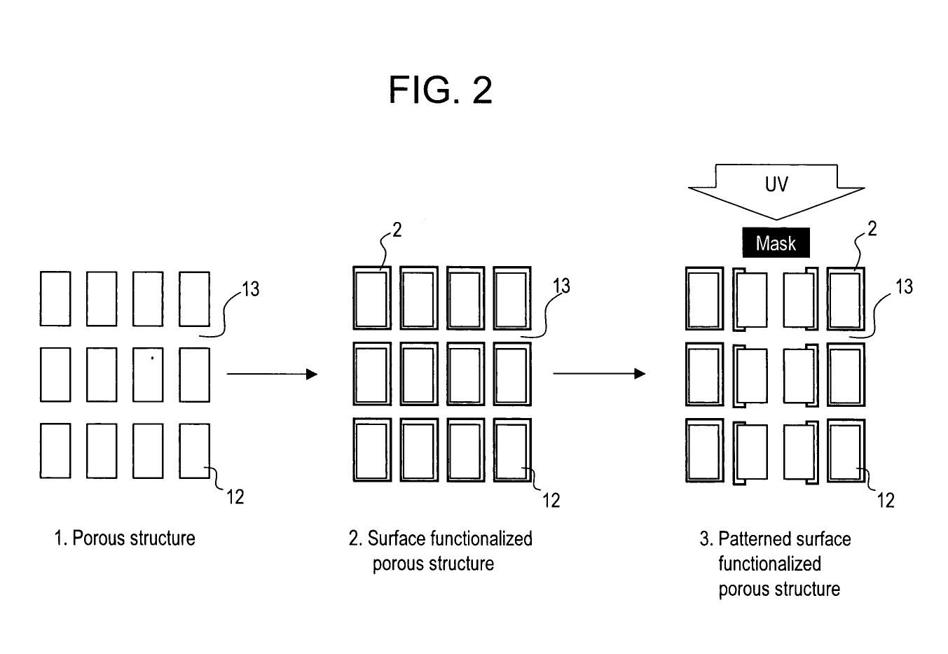

FIG. 2 is an exemplary schematic that depicts one method of manufacturing the multifunctional catalyst system;

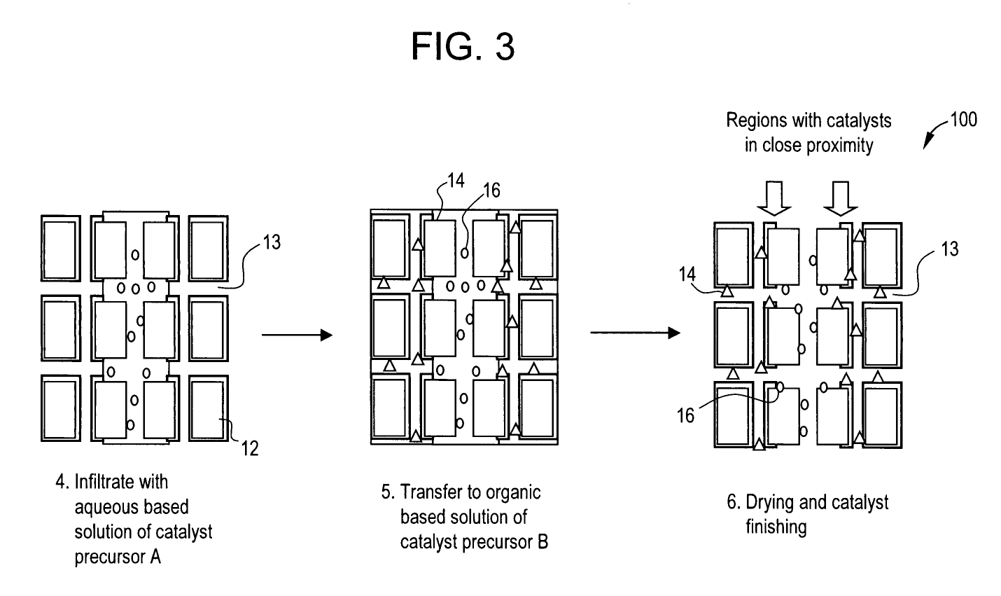

FIG. 3 is a continuation of the FIG. 2 and depicts additional steps in the method of manufacturing the multifunctional catalyst system;

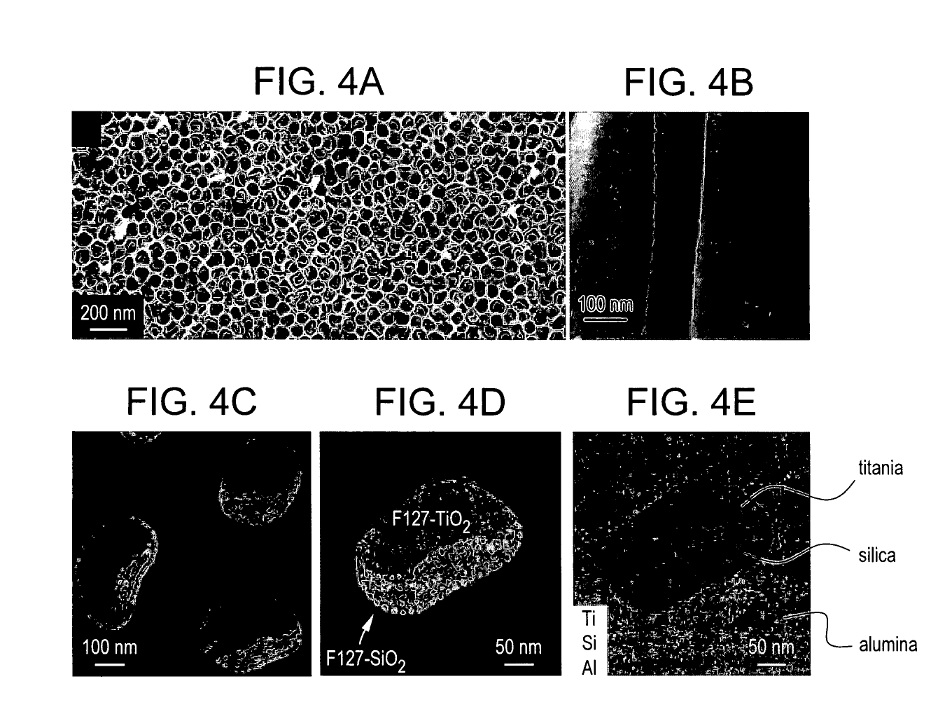

FIG. 4 comprises 5 photomicrographs of a silica-titania mesoporous catalyst substrate taken using scanning electron microscopy and transmission electron microscopy. The low-magnification plan-view (i.e. top-down) SEM image (FIG. 4a) of the AAO membrane shows multiple AAO macropores filled with mesoporous material. In the cross-sectional SEM image (FIG. 4b), the mesoporous SiO₂ phase is visible between the walls of the AAO due to the fracture surface. The TEM images (FIG. 4c-e) provides information about the degree of filling and the relative distribution of silica and titania in the AAO;

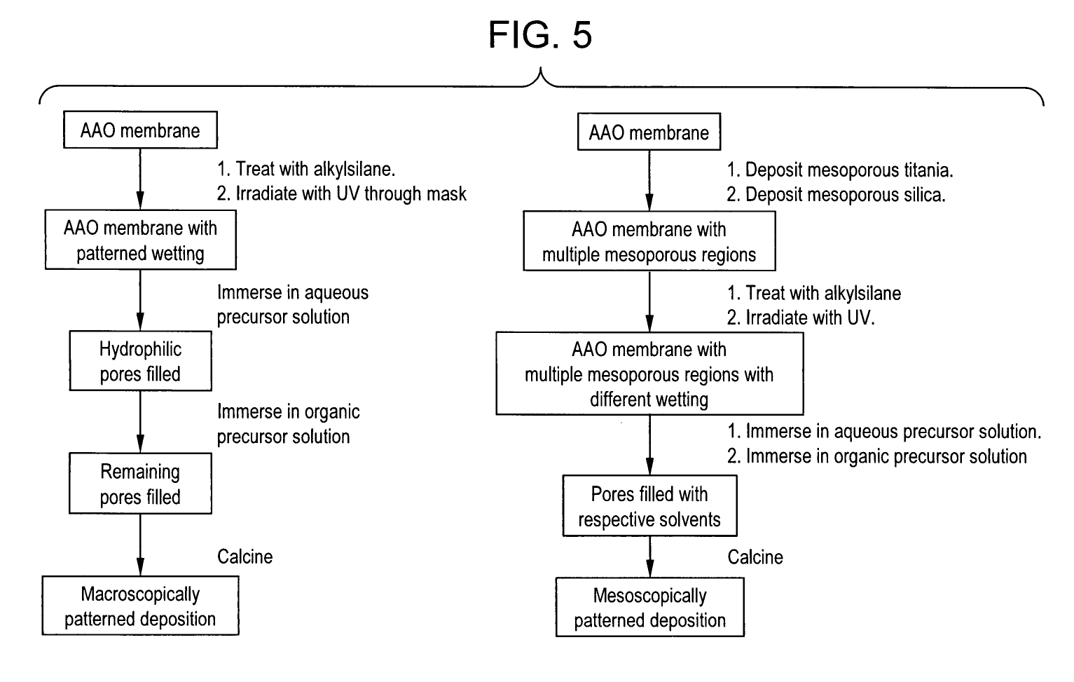

FIG. 5 is a schematic depicting one method of manufacturing a selectively functionalized substrate; and

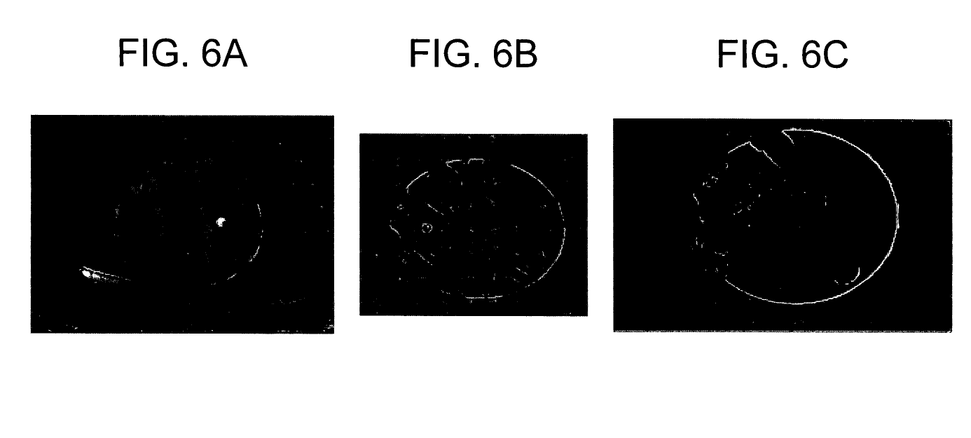

FIGS. 6(a), (b) and (c) each depict optical micrographs of patterned substrates containing ceria and cobalt oxide. The light regions in the optical micrographs contain CeO₂ and the dark regions contain Co₃O₄. The diameter of the AAO membranes is 25 mm. FIG. 6(a) is an optical micrograph after the patterned membrane was immersed in the cerium nitrate solution. FIG. 6(b) shows the membrane after it was dipped in a cobalt 2-ethylhexanoate in toluene solution and dried. FIG. 6(c) shows the membrane after calcination at 500° C. for 5 hours.

### DETAILED DESCRIPTION

It is to be noted that the terms “first,” “second,” and the like as used herein do not denote any order, quantity, or importance, but rather are used to distinguish one element from another. The terms “a” and “an” do not denote a limitation of quantity, but rather denote the presence of at least one of the referenced item. The modifier “about” used in connection with a quantity is inclusive of the stated value and has the meaning dictated by the context (e.g., includes the degree of error associated with measurement of the particular quantity). It is to be noted that all ranges disclosed within this specification are inclusive and are independently combinable.

Disclosed herein is a multifunctional catalyst system comprising a plurality of catalysts, wherein the catalysts are effectively arranged to function synergistically by complimenting each other. In one embodiment, the multifunctional catalyst system comprises two or more individual catalysts that were hitherto incompatible with one another by virtue of their functional characteristics. The individual catalysts are generally disposed upon a substrate and have average catalyst interparticle distances of less than or equal to about 1,000 nanometers. The individual catalysts are mixed together in effective proportions at effective locations or distances within the multifunctional catalyst system to facilitate a synergy between the catalysts that results in the production of desirable products. If these very catalysts were not mixed together in the effective manner disclosed herein the multifunctional catalyst system would not be capable of producing the desired products in a sustained manner.

In another embodiment, the individual catalysts are compatible catalysts (complimentary catalysts) that can be effectively arranged to function more synergistically in the multifunctional catalyst system thereby significantly increasing productivity, improving reaction yield, reducing costs, or the like. The term “plurality of catalysts” is intended to mean “two or more” and as used herein implies “types of particles” or “composition of particles” rather than the number of particles. The term as used herein has the same meaning as the term “plurality of catalyst particles”. Thus “plurality of catalysts” includes different types of catalysts that produce a single product at the same or different reaction rates or it can include different catalysts that produce different products and the same or different reaction rates.

In one embodiment, the multifunctional catalysts comprise a plurality of catalyst particles disposed upon a substrate wherein the interparticle distance between two catalyst particles that catalyze the same or different reactions is about 10 to about 1,000 nanometers. Provision of catalyst particles at length scales of about 10 to about 1,000 nanometers upon a substrate permits the otherwise incompatible catalysts to function synergistically by balancing factors such as the reaction rate, the heat transfer rate, the mass diffusion rate, and the like, that can improve the performance of the multifunctional catalyst system.

In another embodiment, the pores in the substrate can be treated to locate a first catalyst at hydrophobically treated pores located in the substrate, while a second catalyst that catalyzes the same or a different reaction from the first catalyst is disposed in the remaining pores. In this embodiment, an organic solvent may be used to facilitate the deposition of the first catalyst in the hydrophobically treated pores, while an aqueous solvent can be used to facilitate the deposition of the second catalyst in the remaining pores.

Thus, in general, the multifunctional catalyst system comprises a catalytic composition comprising two or more incompatible or complimentary catalysts disposed upon a porous substrate wherein the porous substrate facilitates organization of the catalysts in the substrate on the basis of functional characteristics of the substrate, functional characteristics of the catalyst, or both functional characteristics of the substrate and the catalyst.

Examples of such characteristics include physical characteristics, chemical characteristics, heat transfer characteristics, or the like. Examples of physical characteristics include pore size, pore shape, or pore distribution of the substrate, catalyst particle spacing, catalyst particle orientation, or the like. Examples of chemical characteristics include reactivity, regeneration ability, selectivity, or the like, of the catalyst and/or the substrate. Examples of heat transfer characteristics include heat diffusion between the catalyst particles of opposing functionality, heat diffusion between the catalyst particles and the substrate, or the like.

The term “incompatible catalysts” as defined herein refers to two or more individual catalysts, each of which can individually perform a specific catalytic function when separated from the other individual catalysts, but whose functional characteristics would conflict with one another (i.e., they having opposing functionalities or behaviors) when brought together under uncontrolled conditions such that one of the catalysts would not perform a desired catalytic function. An example of a multifunctional catalyst system having respective opposing functionalities is one where the catalyst system comprises two catalysts, a first catalyst and a second catalyst, one of which ends up producing a product at a rate that facilitates the poisoning of the other catalyst. However, by controlling their opposing functionalities, the two catalysts can function synergistically in the multifunctional catalyst system and manufacture product without being poisoned. In the aforementioned example, one manner of controlling the opposing functionalities is to screen a portion of the first catalyst from reactants thereby lowering its reaction rate so that transformation of the products by the second catalyst can be accomplished at a rate that prevents its poisoning.

The use of a multifunctional catalyst system offers many advantages over other comparable systems that provide the similar catalytic effects, but are not contained within a single system. Multifunctional catalyst systems are generally smaller in size, are cost effective, can be recycled easily and can be easily transported when compared with other commercially available comparative systems. Other commercially available comparative systems generally comprise separate chambers for the individual catalysts so as to prevent poisoning of the catalysts.

As noted above, the multifunctional catalyst system comprises a substrate upon which are disposed a plurality of catalysts. In one embodiment, the substrate can be a porous substrate where catalytic particles are selectively located in order to enhance the production of reactive products. The catalytic particles are generally embedded in the pores. In one embodiment, the composition of the pores and the walls of the substrate can be designed to control chemical stability, catalytic activity and/or surface energy. In another embodiment, the pore architecture of the substrate can be designed to control the diffusion of reactants to the catalyst particles, the perm selectivity as well as the surface area of the catalyst particles that is exposed to the reactants.

In one embodiment, the pores of the substrate can have average pores sizes in the nanometer range. Controlling pore sizes and architecture (shape of the pores) of the substrate can facilitate control of the diffusion properties of the multifunctional catalyst system. The pore sizes and architecture can be used to control the transfer of reactants to the catalyst particles, the transfer of products away from the catalyst particles, the rate of heat build up and dissipation in the multifunctional catalyst system as well as to control the rate of heterogeneous catalytic activity.

As noted above, the structure and size of the substrate pores can be used to control diffusion properties and the heat transfer of the multifunctional catalyst system. The substrate can comprise inorganic materials, polymeric materials, or composites that comprise inorganic materials and polymeric materials. Examples of inorganic materials that can be used in the substrate are inorganic oxides, inorganic carbides, inorganic nitrides, inorganic hydroxides, inorganic oxides having hydroxide coatings, inorganic carbonitrides, inorganic oxynitrides, inorganic borides, inorganic borocarbides, or the like, or a combination comprising at least one of the foregoing inorganic materials. Examples of suitable inorganic materials are metal oxides, metal carbides, metal nitrides, metal hydroxides, metal oxides having hydroxide coatings, metal carbonitrides, metal oxynitrides, metal borides, metal borocarbides, or the like, or a combination comprising at least one of the foregoing inorganic materials.

With reference now to the FIGS. 1 through 3, a multifunctional catalyst system 100 comprises a substrate 10 that comprises walls 12 and pores 14. A reactive coating 2 is disposed upon portions of the walls 12. A first catalyst 14 is disposed those portions of the walls 12 that have a reactive coating 2 disposed thereon. Additional catalysts such as a second catalyst 16 can be disposed directly upon those portions of the walls 12 that are uncoated. Additional catalysts such as a third catalyst, a fourth catalyst, or the like, may be disposed upon the portions of the walls 12 that have the reactive coating as well as the uncoated portions or the walls 12 if desired.

Examples of suitable inorganic oxides for use in the substrate walls 12 include silica (SiO₂), alumina (Al₂O₃), titania (TiO₂), zirconia (ZrO₂), ceria (CeO₂), zinc oxide (ZnO), iron oxides (e.g., FeO, α-Fe₂O₃, γ-Fe₂O₃, Fe₃O₄, or the like), calcium oxide (CaO), manganese oxide (MnO₂ and Mn₃O₄), niobium oxide (Nb₂O₃), tantalum pentoxide (Ta₂O₅), tungsten trioxide (WO₃), tin oxide (SnO₂), haffiium oxide (HfO₂), silicon aluminum oxide (SiAlO₃), silicon titanate (SiTiO₄), zirconium titanate (ZrTiO₄), aluminum titanate (Al₂TiO₅), zirconium tungstate (ZrW₂O₈), yttria stabilized zirconia (YSZ), yttrium oxide (Y₂O₃) or a combination comprising at least one of the foregoing inorganic oxides, wherein the inorganic oxide may optionally be doped with at least one lanthanide element and or at least one transition metal or combinations thereof. Examples of suitable synthetically created inorganic carbides include silicon carbide (SiC), titanium carbide (TiC), tantalum carbide (TaC), tungsten carbide (WC), hafnium carbide (HfC), or the like, or a combination comprising at least one of the foregoing carbides. Examples of suitable synthetically created nitrides include silicon nitrides (Si₃N₄), titanium nitride (TiN), or the like, or a combination comprising at least one of the foregoing. Examples of suitable borides are lanthanum boride (LaB₆), titanium boride (TiB₂), zirconium boride (ZrB₂), tungsten boride (W₂B₅), or the like, or combinations comprising at least one of the foregoing borides.

Exemplary substrates 10 are those having walls 12 that comprise silica (SiO₂), titanium dioxide (TiO₂), zirconium dioxide (ZrO₂), alumina (Al₂O₃), or the like, or a combination comprising at least one of the foregoing.

In one embodiment, the substrate 10 is porous having a porosity of about 10 to about 98 volume percent based on the total volume of the substrate. In another embodiment, the substrate 10 is has a porosity of about 25 to about 95 volume percent based on the total volume of the substrate. In yet another embodiment, the substrate 10 is has a porosity of about 35 to about 90 volume percent based on the total volume of the substrate. An exemplary porosity is about 50 to about 80 volume percent based on the total volume of the substrate.

The substrates generally have high surface areas of about 1 to about 1,000 square meter/gram (m²/g). In one embodiment, the substrates can have surface areas of about 5 to about 950 m²/g. In another embodiment, the substrates can have surface areas of about 10 to about 900 m²/g. In yet another embodiment, the substrates can have surface areas of about 20 to about 850 m²/g.

The average pore sizes for the pores 14 of the substrate can be about 2 to about 50 nanometers. The pore size refers to the size of the diameter of the pore 14. Within this range it is generally desirable for the average pore sizes to be greater than or equal to about 5, specifically greater than or equal to about 10, and more specifically greater than or equal to about 15 nanometers. Also desirable within this range are pore sizes of less than or equal to about 45, specifically less than or equal to about 40, and more specifically less than or equal to about 35 nanometers in diameter. An exemplary average pore size is about 2 to about 15 nanometers. The porous substrate can be monolithic or can be in particle form.

Since the pore sizes may generally be smaller than the average interparticle or interdomain spacing for the catalyst particles, the multifunctional catalyst system is anisotropic. In general the direction of orientation of the catalyst particles may be used to encourage the flow of heat or products produced as a result of catalysis.

Having the pores in the nanometer range permits the catalyst particles to remain in close proximity to each other. This is displayed in the enclosed circle in the FIG. 1. As noted above, the distance between the catalyst particles is chosen to permit the efficient heat and mass transfer during the reactions. From the enclose circle it may be seen that the first catalyst particles 14 and the second catalyst particles 16 are in close proximity to each other, which permits the reaction product of a first catalyzed reaction to be easily consumed in a second catalyzed reaction. Similarly, the interparticle spacing can be chosen to facilitate dissipation or utilization of heat generated during the respective reactions.

Commercially available examples of nanosized metal oxides are NANOACTIVE™ calcium oxide, NANOACTIVE™ calcium oxide plus, NANOACTIVE™ cerium oxide, NANOACTIVE™ magnesium oxide, NANOACTIVE™ magnesium oxide plus, NANOACTIVE™ titanium oxide, NANOACTIVE™ zinc oxide, NANOACTIVE™ silicon oxide, NANOACTIVE™ copper oxide, NANOACTIVE™ aluminum oxide, NANOACTIVE™ aluminum oxide plus, all commercially available from NanoScale Materials Incorporated. Commercially available examples of nanosized metal carbides are titanium carbonitride, silicon carbide, silicon carbide-silicon nitride, and tungsten carbide all commercially available from Pred Materials International Incorporated.

The reactive coating 2 can be any coating that can be applied to portions of the substrate 10 in order to selectively bond catalyst particles to the substrate 10. It is desirable for the coating to be selectively applied to only certain portions of the substrate. In one embodiment, removing portions of the coating from the substrate facilitates the selective coating of the substrate. As can be seen in the FIG. 2, the removal of the coating is accomplished by using ultraviolet (UV) light on unmasked portions of the substrate.

In one embodiment, the reactive coating 2 is applied to the substrate 10 to transform the chemical character of those portions of the walls 12 to which it is applied. The surface functionalization of the walls 12 of the substrate 10 can be used to selectively bond certain desired catalysts to the walls 12. In one embodiment, by applying a reactive coating to the walls 12, the chemical character of the walls is transformed from hydrophilic to hydrophobic or vice versa. In one embodiment, the wall can be transformed into a hydrophobic surface by the reaction of an alkylsilane to the walls 12.

The reactive coating 2 can be applied to about 20 to about 80% of the total surface area of the substrate 10. In one embodiment, the reactive coating 2 can be applied to about 30 to about 70% of the total surface area of the substrate 10. In another embodiment, the reactive coating 2 can be applied to about 40 to about 60% of the total surface area of the substrate 10. In yet another embodiment, the reactive coating 2 can be applied to about 45 to about 55% of the total surface area of the substrate 10.

The plurality of catalysts added to the multifunctional catalyst system can include those having opposing characteristics or incompatible catalyst pairs such as Lewis acids and bases, metal catalysts having various oxidation, hydrophobic and hydrophilic catalysts, reducing and oxidizing catalysts, photocatalysts, enzymes and metal-complex catalysts or the like, or a combination comprising at least one of the foregoing incompatible catalyst pairs.

In one example, a multifunctional catalyst system that comprises both electrophilic and nucleophilic sites can be used to conduct a Fischer Tropsch reaction. The Fischer-Tropsch reaction involves the reductive polymerization of carbon monoxide (an electrophile) in the presence of hydrogen (a nucleophile) to form linear hydrocarbons, olefins and/or alcohols. The reaction involves coordination of carbon monoxide and hydrogen to a catalyst surface, which has both Lewis acidic and Lewis basic sites. The coordinated carbon monoxide is then reduced to methylene and methyl species that grow chains on the surface. This reduction and growth and eventual formation of products involves both electrophilic sites (Lewis acidic) for coordination of carbon monoxide and hydrogen, and nucleophilic sites (Lewis basic) for coordination of electrophiles that drive the reaction to completion.

Another example of a reaction utilizing an incompatible pair is an acid-base pair that comprises the acid-catalyzed pinacol-pinacolone rearrangement followed by a base-promoted condensation of the ketone with malononitrile.

An example of an oxidation-reduction sequence is the conversion of 1-(4-nitrophynylenthanol) into 4-aminoacetophenone, where the oxidant is pyridinium dichromate and the reductant is activated by RhCl[P(C₆H₅)₃]₃.

An example of a reaction utilizing an enzyme metal-complex catalyst pair is the hydrogenation of a carbon-carbon double bond catalyzed by either RhCl[P(C₆H₅)₃]₃ or by Rh₂Co₂(CO)₁₂ and an esterification reaction catalyzed by lipase.

The ratio of the weight of the catalyst to the weight of the substrate 10 is up to about 10 wt % based on the total weight of the multifunctional catalyst system. An exemplary ratio for the weight of the catalyst to the weight of the substrate 10 is about 1 to about 8 wt % based on the total weight of the multifunctional catalyst system.

With reference now to the FIGS. 2 and 3, in one embodiment, in one exemplary method of manufacturing the multifunctional catalyst system, a porous substrate 10 that has hydrophilic walls 12 is treated with an alkyl silane to convert a portion of the hydrophilic walls to hydrophobic walls. The porous substrate 10 can comprise a metal oxide such as, for example, alumina or silica. A suitable example of an alkyl silane is trimethylchlorosilane (TMCS). The porous substrate 10 having surface functionalized walls 12 is subjected to selective degradation of the alkyl silane using ultraviolet (UV) light. As depicted in the FIG. 2, a mask may be used in order to facilitate the selective degradation of the alkyl silane.

After the selective degradation, the porous substrate 10 having patterned hydrophobic and hydrophilic pore walls is impregnated with catalytic particles comprising a first catalyst. As shown in the FIG. 3, the process of disposing the first catalyst into the porous substrate 10 comprises infiltrating the substrate 10 with an aqueous based solution that comprises a catalyst precursor to the first catalyst. Since the aqueous based solution has an affinity for the hydrophilic regions, the catalyst precursor to the first catalyst is generally deposited in the hydrophilic regions. The catalyst precursor may be subjected to optional treatments such as heating, additional reactions, and the like, to convert the catalyst precursor to the first catalyst. Following a first optional drying process to remove the aqueous based solution, the porous substrate 10 is impregnated with an organic solution of a second catalyst. Since the organic solution has an affinity for the hydrophobic regions, the second catalyst is generally disposed in the hydrophobic regions of the porous substrate 10. The porous substrate 10 may then be subjected to a second optional drying process to remove any traces of residual solutions in the hydrophilic and hydrophobic regions and to form the multifunctional catalyst system.

In one embodiment, the aqueous based solution that comprises the first catalyst (or the precursor to the first catalyst) and the organic solution that comprises the second catalyst (or the precursor to the second catalyst) are both permitted to infiltrate the substrate simultaneously. The immiscibility of the aqueous based solution with the organic solution permits the deposition of the first catalyst and the second catalyst into separate regions on the substrate. In one embodiment, the organic solution comprising the second catalyst is deposited on walls that are rendered hydrophobic by the alkylsilane. The aqueous solution is deposited on those portions of the walls that are hydrophilic.

The method of selective functionalization described above may be used to produce multifinctional catalyst systems that have nano-sized regions having different catalysts in close proximity. As noted above, this approach may be used to permit “incompatible catalysts” such as acids and bases or reducing and oxidizing catalysts in close proximity. Such multifunctional catalyst systems can be used for conducting multi-stage reaction processes.

In one exemplary embodiment, in one method of using the multifunctional catalyst system, a fluidized bed, a packed column or a reaction vessel comprising the multifunctional catalyst system may be exposed to the reactants. It is generally desirable for the reactants to be in the form of fluids. Fluid reactants in the form of liquids or gases are desirable since they do not clog the pores of the multifunctional catalyst system. The reactants may be fed to the fluidized bed, the packed column or the reaction vessel under gravity of under pressure. The temperature of the multifunctional catalyst system may be elevated to a value that promotes the desirable reactions without any poisoning of the catalysts. The reaction products may be in the form of fluids or solids. It is generally desirable for the reaction products to be in the form of fluids. If the reaction products are in the form of solids, it is desirable for the solids to be in powder form so that they can be easily displaced through the pores of the multifunctional catalyst system.

Thus by using the multifunction catalyst system described herein products that are generally produced in chemical plants comprising several large pieces of equipment can now be advantageously manufactured in equipment that is significantly smaller than the industrial size equipment employed in plants. The multifunctional catalyst system can thus be used to save costs associated with equipment as well as with the energy used to run and maintain large pieces of industrial equipment.

The following examples, which are meant to be exemplary, not limiting, illustrate the methods of manufacturing and operation of the multifunctional catalyst system described herein.

### EXAMPLES

### Example 1

This example was conducted to demonstrate how porous substrates having mesoporous structures can be prepared for use in a multifunctional catalyst system. Heterogeneous mesoporous oxides were synthesized in an anodized aluminum oxide (AAO) membrane using a multi-stage immersion approach described above for the production of hydrophobic and hydrophilic pores.

The pores of an AAO membrane having an average pore size of 200 nm were partially filled with a first composition, calcined, subjected to a second infiltration to fill the remaining volume and calcined once more. The AAP membrane is commercially available from Whatman. In this example, mesoporous TiO₂ (or ZrO₂) was produced in the first filling step, followed by complete filling of the remaining space within the AAO macropore with mesoporous SiO₂. A nonionic block copolymer, EO₁₀₆-PO₇₀EO₁₀₆ [Pluronic F127], was used as the template in this example. The Pluronic surfactant was obtained from BASF Corporation. Hydrochloric acid (HCl, 37 wt. %), ethanol, tetraethoxysilane (TEOS) and titanium (IV) ethoxide (TEOT) and zirconium t-butoxide were purchased from Aldrich and used in as-received condition. The AAO membranes (25 mm and 47 mm with 200 nm pores, 50 μm thick) were purchased from Whatman and used as received.

The precursor solution for the first infiltration was prepared by dissolving 1.5 grams of F127 block copolymer in 24 grams of ethanol at room temperature. In the case of TiO₂/SiO₂ heterogeneous structures, a second solution was prepared in which 8.4 grams of TEOT was added to 6.0 grams of concentrated HCl and 0.4 grams distilled water at room temperature. In the case of ZrO₂/SiO₂ heterogeneous structures, the second solution contained 8.0 grams of zirconium t-butoxide added to 4.0 grams of concentrated nitric acid (70 wt %) and 4.0 grams distilled water at room temperature. The solutions were stirred until clear. The second solution was added to the first solution, stirred for 5 minutes and transferred to a Petri dish.

The AAO was placed horizontally on elastomer supports in the precursor solution. The height of the supports was less than the initial depth of the precursor solution allowing complete immersion of the AAO. The solution was allowed to evaporate in air until it formed a continuous, transparent gel, after a period of 1 to 2 days. The AAO membrane was exposed during this process by the recession of the fluid level due to evaporation. The membrane was removed from the supports and heated at 400° C. for 4 hours in air to remove the template. The partially filled AAO membrane was then subjected to a second growth stage using a solution containing 3 grams F127, 6 grams pH 0.4 HCl, 18 grams ethanol and 7.7 grams TEOS. The partially filled AAO membranes were immersed in this solution. After gelation, the membranes were recovered and heated at 600° C. for 4 hours in air to remove the template.

After being heated to remove the templates, the samples were examined using scanning electron microscopy and transmission electron microscopy. High resolution scanning electron microscopy (HRSEM) analysis was performed in a Hitachi model S-4500 field emission scanning electron microscope (FE SEM) equipped with a PGT PRISM digital EDS Xray detector and IMIX analysis system using a beam energy of 5 kV. The samples were prepared by fracturing the AAO membrane and mounting the recovered pieces onto aluminum stubs using conductive carbon tape and paste. A thin coating of Pt was sputtered onto the membranes to reduce charging.

Transmission electron microscopy (TEM) samples were prepared from fractured membranes by dimpling and ion milling procedures. Before ion milling, the dimpled membranes were glued onto slotted Cu grids for added support. Samples were cooled with liquid nitrogen during ion milling, and coated with a thin carbon film prior to TEM analysis in order to minimize structural damage resulting from ion- and electron-beam exposure, respectively. Imaging was performed using a FEI Tecnai F20 transmission electron microscope at an accelerating voltage of 200 kV. Energy-filtered imaging was performed using the Si K, Ti L₃ Zr L₃, and Al K-edges to resolve the Si-, Ti-, Zr-, and Al-rich regions, respectively. Composite chemical maps were created post-acquisition by combining the individual elemental images obtained by energy-filtered TEM.

FIG. 4 shows SEM and TEM images of the TiO₂/SiO₂ mesoporous heterogeneous composite. The low-magnification plan-view (i.e. top-down) SEM image (FIG. 4a) of the AAO membrane shows multiple AAO macropores filled with mesoporous material. In the cross-sectional SEM image (FIG. 4b), the mesoporous SiO₂ phase is visible between the walls of the AAO due to the fracture surface. The TEM images (FIG. 4c-e) provides information about the degree of filling and the relative distribution of silica and titania in the AAO. The degree of filling appears different at low magnification SEM images (FIG. 4a) compared to the higher magnification TEM images (FIG. 4c-e) merely because of the sample preparation. The dark regions in the AAO-macropores shown in the SEM image of FIG. 4a are likely due to partial shrinkage or recession of the filler in the irregular surface of the AAO.

The TEM images are prepared through ion-milling and show that the interior of the AAO-macropores are well filled by the heterogeneous mesoporous composite. The contrast difference in the filler stems primarily from differences in mass (or atomic number Z), with the darker regions corresponding to the TiO₂. Energy-filtered imaging (FIG. 4e) shows that the regions of different composition remain distinct with minimal coating of the mesoporous titania by the mesoporous silica deposited in the second growth step occurs. A higher magnification image of a single AAO pore (FIG. 4d) shows that both the TiO₂ and SiO₂ regions are mesoporous. Despite the use of the same surfactant template, it is noted that the pore architectures in each of the metal oxides was slightly different, as evidenced by the TEM image which shows a marked contrast difference likely related to the different degree of pore organization and/or wall crystallinity displayed by the heterogeneous mesoporous composites.

In the titania region, the pores appeared smaller (8-10 nm, with a slightly elliptical cross-section) and had noticeably poorer ordering. This may be due to the high concentration of ions present in the precursor solution and differences in solubility of the alkoxide precursors in the F127 template that lead to different behavior during the gelation process. The effect of concentration is currently being studied and will be reported elsewhere. For comparison, the SiO₂ regions contained pores that were 13 to 16 nm in diameter. Examination of multiple pores indicated that each composition occupied about half of the pore for the synthesis parameters used. However, the similarity between the shape of the titania region and the shape of the pore suggests shrinkage during the intermediate heating step.

Thus from the FIG. 4, it can be seen that heterogeneous mesoporous oxide composites with multiple regions of distinct wall composition can be systematically synthesized using a multi-step processing approach. Well-ordered titania—silica composite structures were readily obtained, and the method may be applicable to a variety of additional chemical compositions. Although AAO membranes were used in this work, the method is generally applicable to other porous scaffolds.

### Example 2

This example was performed to demonstrate how a substrate comprising silica and titania can be selectively functionalized. FIG. 5 is a schematic depiction of the approach. This method is based on the exclusion of water from hydrophobic pores; when a porous structure with hydrophobic and hydrophilic pores is immersed in an aqueous solution, only the hydrophilic pores are filled. A second material can be deposited in the hydrophobic pores by subsequently immersing the material into an organic solution. However, since organic solvents wet both hydrophobic and hydrophilic pores, this second immersion is performed while the hydrophilic pores are still filled with water.

In this example, the hydrophobic-hydrophilic patterning was accomplished in the AAO membrane of Example 1 using a two-step approach. In the first step, the pores are uniformly treated with an alkylsilane, which chemically reacts with the surface and renders the pores hydrophobic. In the second step, the pores can be irradiated with UV light, which degrades the alkyl structure. Membranes were patterned with a combination of ceria and cobalt oxide. Individually, these materials have been used to as catalysts for reverse water gas shift reactions and Fischer Tropsch reactions respectively.

An AAO membrane was treated with 76 mM octyltrichlorosilane (OTS) in toluene for 1 hour and irradiated through a metal mask using short wave UV (254 nm). The OTS converts portions of the substrate from hydrophilic to hydrophobic. The membrane was then dipped into an aqueous solution for 1 minute and then transferred to an organic precursor solution for 1 minute. The membrane was then dried in air for 30 minutes and calcined at 500° C. for 5 hours to convert the precursor into the final product. Cerium nitrate, cobalt 2-ethylhexanoate, copper (II) neodecanate (˜60% toluene), octyltrichlorosilane (OTS), titanium ethoxide, and toluene were purchased from Aldrich and used as received. Anodic alumina (AAO) membranes (Whatman, 200 nm, 50 um thick) were rinsed with water and heated to 550° C. before use. F127 block copolymer was donated by BASF.

As noted above, the patterned membrane is immersed in a 1M Ce(NO₃)₃ (cerium nitrate) solution. The aqueous solution selectively fills the hydrophilic pores. The membrane was then dipped in a cobalt 2-ethylhexanoate in toluene solution and dried. The ratio of cobalt 2-ethylhexanoate to toluene is 5% wt. The patterned membrane comprising the ceria and cobalt oxide was subjected to optical microscopy during various stages of the manufacturing process. The results are shown in the FIG. 6. The images in FIG. 6 show the AAO membrane at different points in the functionalization process. They also show selective wetting of the hydrophilic and hydrophobic regions. FIG. 6(a) is an optical micrograph after the patterned membrane was immersed in the cerium nitrate solution. The aqueous solution selectively fills the hydrophilic pores. The optical contrast in the membrane is due to infiltration of the aqueous solution into the UV irradiated regions. The paper towel in the background is visible through the wetted regions because of the close index match between the AAO membrane and water. The dry regions have a higher index mismatch and remain opaque.

FIG. 6(b) shows the membrane after it was dipped in a cobalt 2-ethylhexanoate in toluene solution and dried. The dark color indicates the presence of cobalt 2-ethylhexanoate. The toluene solution was excluded from the hydrophilic pores due to the presence of water. A few spots of cobalt solution were left on the membrane after removal from the organic solution. These spots dried leaving behind small cobalt complex deposits on the surface of the AAO membrane.

A control experiment in which a dry patterned membrane was dipped in the cobalt 2-ethylhexanoate resulted in a uniformly dark membrane. Toluene filled all of the pores and excluded the water. Subsequent dipping of this wet membrane in an aqueous solution did not have any effect. The water did not displace toluene from the hydrophilic pores. The third image (FIG. 6(c)) shows the membrane after calcination at 500° C. for 5 hours. The black regions corresponding to the presence of cobalt oxide appear to have expanded. This may be due to volatilization of the cobalt 2-ethylhexanoate during the heating step.

Nanoscale patterning can be achieved in an analogous manner as that described above using a chemically patterned mesoporous structure. In this case, a mesoporous structure comprising domains with different wetting properties can be prepared as demonstrated in the Example 1. Since the length scale of the desired pattern is comparable to or less than the wavelength of UV light use to produce the pattern, the pattern is produced by a combination of the structural heterogeneity in the porous support and the use of UV light.

The mesoporous oxides of the Example 1 can be treated with an alkylsilane and irradiated with UV for a controlled duration. The wetting contrast emerges from the different rates of alkylsilane degradation in silica and titania regions. Degradation is more rapid in the porous titania regions because titania acts as a photocatalyst. After irradiation, an AAO membrane with hydrophilic mesoporous titania regions and hydrophobic mesoporous silica regions is obtained.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention.

What is claimed is:

1. A multifunctional catalyst system comprising:
a substrate; and
a catalyst pair disposed upon the substrate; wherein the catalyst pair comprises a first catalyst and a second catalyst; and wherein an average particle or domain spacing between particles or domains comprising the first catalyst or the second catalyst is about 10 to about 1,000 nanometers.

2. The multifunctional catalyst system of claim 1, wherein the substrate is porous.

3. The multifunctional catalyst system of claim 2, wherein the substrate has a porosity of about 10 to about 90 volume percent based on the total volume of the substrate.

4. The multifunctional catalyst system of claim 1, wherein the substrate comprises inorganic materials, polymeric materials, or composites that comprise inorganic materials and polymeric materials.

5. The multifunctional catalyst system of claim 1, wherein the inorganic materials comprise inorganic oxides, inorganic carbides, inorganic nitrides, inorganic hydroxides, inorganic oxides having hydroxide coatings, inorganic carbonitrides, inorganic oxynitrides, inorganic borides, inorganic borocarbides, or a combination comprising at least one of the foregoing inorganic materials.

6. The multifunctional catalyst system of claim 1, wherein the inorganic materials comprise metal oxides, metal carbides, metal nitrides, metal hydroxides, metal oxides having hydroxide coatings, metal carbonitrides, metal oxynitrides, metal borides, metal borocarbides, or a combination comprising at least one of the foregoing inorganic materials.

7. The multifunctional catalyst system of claim 6, wherein the metal oxide comprises silica, alumina, titania, zirconia, ceria, manganese oxide, zinc oxide, iron oxide, calcium oxide, manganese dioxide, niobium oxide, tantalum pentoxide, tungsten trioxide, tin oxide, hafnium oxide, silicon aluminum oxide, silicon titanate, zirconium titanate, aluminum titanate, zirconium tungstate, yttria stabilized zirconia, yttrium oxide or a combination comprising at least one of the foregoing inorganic oxides.

8. The multifunctional catalyst system of claim 1, wherein the substrate has a selectively functionalized surface.

9. The multifunctional catalyst system of claim 8, wherein the selectively functionalized surface comprises regions of mutual incompatibility.

10. The multifunctional catalyst system of claim 1, wherein the catalyst pair is an incompatible catalyst pair.

11. The multifunctional catalyst system of claim 1, wherein the catalyst pair is a complimentary catalyst pair.

12. The multifunctional catalyst system of claim 11, wherein the incompatible catalyst pair comprises a Lewis acid and a Lewis base, two metal catalysts having different oxidation states, a hydrophobic catalyst and a hydrophilic catalyst, a reducing catalyst and an oxidizing catalyst, an enzyme and a metal-complex catalyst, or a combination comprising at least one of the foregoing incompatible catalyst pairs.

13. The multifunctional catalyst system of claim 1, wherein the first catalyst is a hydrophilic catalyst and the second catalyst is a hydrophobic catalyst.

14. The multifunctional catalyst system of claim 1, wherein a ratio of the weight of the catalyst to the weight of the substrate 10 is up to about 10 wt % based on the total weight of the multifunctional catalyst system.

15. The multifunctional catalyst system of claim 1, wherein an average particle or domain size for particles or domains that comprise the first catalyst or the second catalyst is up to about 1,000 nanometers.

16. The multifunctional catalyst system of claim 1, wherein the average particle spacing or the average domain spacing for particles or domains that comprise the first catalyst or the second catalyst is about 10 nanometers to about 100 nanometers.

17. A process that employs the multifunctional catalyst system of claim 1.

18. The process of claim 17, wherein the process is a multistage process.

19. An article manufactured from the multifunctional catalyst system of claim 1.

20. A multifunctional catalyst system comprising:
a substrate; and
an incompatible catalyst pair disposed upon the substrate; wherein the incompatible catalyst pair comprises a first catalyst and a second catalyst; and wherein an average particle or domain spacing between particles or domains comprising the first catalyst or the second catalyst is effective to produce a desired product that would not be produced if the average particle or the average domain spacing between the first catalyst and the second catalyst was changed.

21. The multifunctional catalyst system of claim 20, wherein the average particle spacing or the average domain spacing between the first catalyst and the second catalyst is about 10 nanometers to about 1,000 nanometers.

22. The multifunctional catalyst system of claim 20, wherein the average particle spacing or the average domain spacing between the first catalyst and the second catalyst is about 10 nanometers to about 1,000 nanometers.

23. The multifunctional catalyst system of claim 20, wherein the substrate has a porosity of about 10 to about 90 volume percent based on the total volume of the substrate.

24. The multifunctional catalyst system of claim 20, wherein the substrate comprises inorganic materials, polymeric materials, or composites that comprise inorganic materials and polymeric materials.

25. The multifunctional catalyst system of claim 20, wherein the substrate has a selectively functionalized surface.

26. The multifunctional catalyst system of claim 25, wherein the selectively functionalized surface comprises regions of mutual incompatibility.

27. A process comprising:
selectively functionalizing a substrate to form a functionalized substrate;
reacting a first catalyst to a first region of the functionalized substrate; and
reacting a second catalyst to a second region of the functionalized substrate; wherein an average particle or domain spacing between particles or domains comprising the first catalyst or the second catalyst is about 10 to about 1,000 nanometers.

28. The process of claim 27, further comprising impregnating the functionalized substrate with a first solution comprising a precursor to the first catalyst or with a first solution that comprises the catalyst.

29. The process of claim 28, further comprising impregnating the functionalized substrate with a second solution comprising a precursor to the second catalyst or with a second solution that comprises the catalyst.

30. The process of claim 27, wherein the first catalyst is a hydrophilic catalyst.

31. The process of claim 28, wherein the second catalyst is a hydrophobic catalyst.

32. The process of claim 27, wherein the first catalyst and the second catalyst form an incompatible pair.

33. The process of claim 27, wherein the first catalyst and the second catalyst form a complimentary pair.

34. The process of claim 27, further comprising converting the precursor to the first catalyst into the first catalyst.

35. The process of claim 28, further comprising converting the precursor to the second catalyst into the second catalyst.

36. A multifunctional catalyst system manufactured by the method of claim 27.

37. A method comprising:
catalyzing a first reaction using a first catalyst; and
catalyzing a second reaction using a second catalyst; wherein the first catalyst and the second catalyst are disposed upon a substrate and further wherein an average particle or domain spacing between particles or domains comprising the first catalyst or the second catalyst is about 10 to about 1,000 nanometers.

38. The method of claim 37, wherein an output from the first reaction is used as an input for the second reaction.

39. The method of claim 37, wherein heat generated in the first reaction is consumed to facilitate the second reaction.

40. An article manufactured by the method of claim 37.
